(19) United States
(12) Patent Application Publication
(10) Pub. No.: US 2003/0143022 A1
(43) Pub. Date: Jul. 31, 2003

(54) Connecting rod

(75) Inventor: Stefan Jager, Schusselfeld (DE)

Correspondence Address: OSTROLENK FABER GERB & SOFFEN, 1180 AVENUE OF THE AMERICAS, NEW YORK, NY, 100368403

(73) Assignee: INA-Schaeffler KG

(21) Appl. No.: 10/355,655

(22) Filed: Jan. 29, 2003

(30) Foreign Application Priority Data
Jan. 29, 2002 (DE) 102 03 266.1

(51) Int. Cl. B25G 3/00

(52) U.S. Cl. 403/345

(57) ABSTRACT

A connecting rod according to the invention is joined together from two sheet-metal parts (3, 4). The connecting rod has an upper connecting-rod eye (1) and a lower connecting-rod eye (2). The two sheet-metal parts (3, 4) each have a socket (11, 12) and a collar (7, 8) in each case forming one of the connecting-rod eyes (1, 2), the one collar (7, 8) of the one sheet-metal part (3, 4) engaging in the socket (11, 12) of the other sheet-metal part (3, 4), and the collar (7, 8) of the other sheet-metal part engaging in the socket (11, 12) of the first sheet-metal part (3, 4).

### DESCRIPTION

The present invention relates to connecting rods as are used, in particular, in smaller combustion engines or in small piston compressors.

DD 146 483, for example, has disclosed a sheet-metal connecting rod which is composed of two sheet-metal parts. The upper and lower connecting-rod eyes are formed by the connecting-rod parts being joined together in pairs by drawn collars. The plane of partition runs transversely through the connecting-rod eye. In addition to the formation of the bearing points, the drawn collars at the same time bring about an angular profile which is continuously and steadily curved in the highly stressed cross sections of the connecting-rod small end and the connecting-rod eye. Depending on the precision required, calibration of the connecting-rod bearing points can be undertaken before the rolling-contact bearings or sliding bearings are fitted into the connecting rod. If the two sheet-metal parts are not aligned satisfactorily with respect to each other or if that part of the connecting-rod eye formed on the one sheet-metal part is not aligned satisfactorily with that part of the connecting-rod eye which is formed on the other sheet-metal part, a rolling-contact bearing ring, for example, cannot be introduced into the connecting-rod eye, since there is an impact edge caused by one of the two sheet-metal parts in the interior of the connecting-rod eye.

The object of the present invention is to specify a connecting rod according to the features of the preamble of claim 1, in which the connecting-rod eyes are formed satisfactorily.

According to the invention, this object is achieved in that the two sheet-metal parts each have a socket and a collar in each case forming one of the connecting-rod eyes, the one collar of the one sheet-metal part engaging in the socket of the other sheet-metal part, and the collar of the other sheet-metal part engaging in the socket of the first sheet-metal part. This means that the one sheet-metal part comprises the lower connecting-rod eye and the other sheet-metal part comprises the upper connecting-rod eye. An impact edge in the interior cannot arise, since the two connecting-rod eyes are each formed on just one sheet-metal part. The two sheet-metal parts can be joined together without any problem. The sockets and the collars are preferably coordinated with one another in such a manner that after the collars have been introduced into the sockets, the two sheet-metal parts are aligned satisfactorily with respect to each other. The two connecting-rod eyes can have different diameters. The two sheet-metal parts can be of identical design, so that the tooling costs are reduced. If the sheet-metal parts are of identical design, the two sheet-metal parts, in order to be joined together, are rotated relative to each other in such a manner that the sockets and the corresponding collars of the two sheet-metal parts lie satisfactorily opposite one another.

The two sheet-metal parts are preferably produced by deep-drawing with both the socket and the collar being drawn out of the sheet, i.e. being connected integrally to the sheet-metal part. Since the collar engages in the other sheet-metal part, it is advantageously appropriate for the collar to be connected fixedly to the other sheet-metal part in each case.

The socket can advantageously be formed by a further collar which is molded integrally onto the sheet-metal part. Accordingly, the socket can be formed by deep-drawing at reasonable cost.

The collar can advantageously be supported radially on the socket. This prevents undesirable deformations or deflections of the connecting-rod eyes. The outside diameter of the collar and the inside diameter of the socket can be coordinated in such a manner that a play-free engagement is formed when the collar is pressed into the socket. After it has been pressed in, the two sheet-metal parts are connected fixedly to each other with a radial support of the collar being ensured.

If the two collars engage in one another with play, a satisfactory fastening of the two sheet-metal parts to each other can be ensured by a calked connection to the other sheet-metal part in each case being provided at the free end of the collar. The radial support takes place here at the free end of the collar.

However, instead of a calked connection, adhesive or soldering tin for a fixed connection of the two sheet-metal parts to each other may also be placed between the collar and the socket. The collars and the sockets may, however, also be welded to one another.

The invention will be explained in greater detail below with reference to an exemplary embodiment illustrated in two figures, in which:

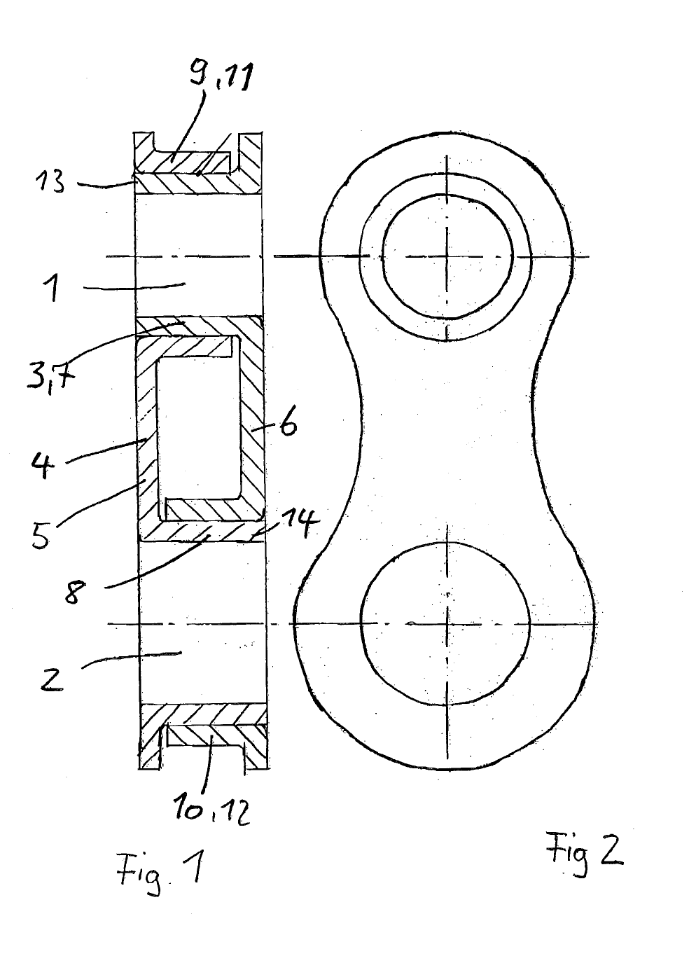

FIG. 1 shows a longitudinal section through a connecting rod according to the invention, and

FIG. 2 shows a view of the connecting rod according to the invention from FIG. 1.

FIG. 1 shows, in longitudinal section, a connecting rod according to the invention having an upper connecting-rod eye 1 and a lower connecting-rod eye 2. The connecting rod is composed of two sheet-metal parts 3, 4. The two sheet-metal parts 3, 4 in each case comprise a basic sheet 5, 6, a respective collar 7, 8 forming the upper connecting-rod eye 1 or the lower connecting-rod eye 2, the said collars both being drawn out of the basic sheet 5, 6, and in each case a further collar 9, 10 which is drawn out of the basic sheet 5, 6 and forms a socket 11, 12 for the first-mentioned collars 7, 8.

The two sheet-metal parts 3, 4 nested one in the other in this manner form the connecting rod according to the invention, it being possible to introduce, for example, rolling-contact bearing rings into the connecting-rod eyes 1, 2 without further calibrating processes. The collar 7 of the one sheet-metal part 3 is inserted into the socket 11 of the other sheet-metal part 4, and the collar 8 of the other sheet-metal part 4 is inserted into the socket 12 of the first sheet-metal part 3. The two collars 7, 8 are supported radially on the associated sockets 11, 12.

In the exemplary embodiment illustrated, a fixed connection between the two sheet-metal parts 3, 4 can be ensured by the collars 7, 8 being pressed into the sockets 11, 12.

As an alternative or in addition, provision can be made for a calked connection to the other sheet-metal part 3, 4 in each case to be provided at the free ends 13, 14 of the two collars 7, 8. Even if there is to be radial play or a radial distance between the socket 11, 12 and the collar 7, 8, the calked connection at the free end of the collar 7, 8 ensures a satisfactory radial support on the associated sheet-metal part 3, 4.

As an alternative, a fixed connection of the two sheet-metal parts 3, 4 to each other can also be obtained by adhesive or soldering tin being placed between the collars 7, 8 and the sockets 11, 12.

The two sheet-metal parts 3, 4 may be of structurally identical design, this not being illustrated. In the event of being structurally identical, only low tooling costs occur and the connecting rods according to the invention can be produced simply and cost-effectively.

### Reference Numbers

| | |
|---|---|
| 1 | Upper connecting-rod eye |
| 2 | Lower connecting-rod eye |
| 3 | Sheet-metal part |
| 4 | Sheet-metal part |
| 5 | Basic sheet |
| 6 | Basic sheet |
| 7 | Collar |
| 8 | Collar |
| 9 | Further collar |
| 10 | Further collar |
| 11 | Socket |
| 12 | Socket |
| 13 | Free end |
| 14 | Free end |

1. A connecting rod which is joined together from two sheet-metal parts (3, 4) and which has an upper connecting-rod eye (1) and a lower connecting-rod eye (2), wherein the two sheet-metal parts (3, 4) each have a socket (11, 12) and a collar (7, 8) in each case forming one of the two connecting-rod eyes, the collar (7, 8) of the one sheet-metal part (3, 4) engaging in the socket (11, 12) of the other sheet-metal part (3, 4), and the collar (7, 8) of the other sheet-metal part (3, 4) engaging in the socket (11, 12) of the first sheet-metal part (3, 4).

2. The connecting rod as claimed in claim 1, in which the collar (7, 8) of the one sheet-metal part (3, 4) is connected fixedly to the other sheet-metal part (3, 4), and in which the collar (7, 8) of the other sheet-metal part (3, 4) is connected fixedly to the first sheet-metal part (3, 4).

3. The connecting rod as claimed in claim 1, in which the collar (7, 8) is molded integrally onto the sheet-metal part (3, 4).

4. The connecting rod as claimed in claim 1, in which the socket (11, 12) is formed by a further collar (9, 10) which is molded integrally onto the sheet-metal part (3, 4).

5. The connecting rod as claimed in claim 1, in which the outside diameter of the collar (7, 8) is supported radially on the socket (11, 12).

6. The connecting rod as claimed in claim 5, in which a calked connection to the other sheet-metal part (3, 4) in each case is formed at the free end of the collar (7, 8).

7. The connecting rod as claimed in claim 5, in which adhesive or soldering tin for a fixed connection of the two sheet-metal parts (3, 4) to each other is provided between the collar (7, 8) and the socket (11, 12).

8. The connecting rod as claimed in claim 2, in which the collars (7, 8) are welded to the sockets (11, 12).
